(19) United States
(12) Patent Application Publication
(10) Pub. No.: US 2026/0213664 A1
(43) Pub. Date: Jul. 23, 2026

(54) POWER CONVERTER AND METHOD FOR CONTROLLING THE SAME

(71) Applicant: Delta Electronics, Inc., Taoyuan City (TW)

(72) Inventor: SHANG KAY YANG, Taoyuan City (TW)

(21) Appl. No.: 19/184,525

(22) Filed: Apr. 21, 2025

(30) Foreign Application Priority Data
Jan. 17, 2025 (CN) 202510079116.7

(51) Int. Cl. H02M 3/335

(52) U.S. Cl. CPC H02M 3/3353

(57) ABSTRACT

Power converters and methods for controlling the same are disclosed and include primary sides of two transformers connected in series to form a primary series assembly and an input switch assembly operating in a full-bridge mode or a half-bridge mode. In a first configuration, the primary series assembly and a capacitor are connected in series between two nodes of the input switch assembly, and a control module is electrically connected to the input switch assembly. Alternatively, in the second configuration, a node of the input switch assembly is electrically connected to a node formed in a series connection of two input capacitors through a back-to-back switch assembly, and the control module is electrically connected to the input switch assembly and the back-to-back switch assembly. In the full-bridge mode, there is a phase shift value between control signals of two switches.

### CROSS REFERENCE TO RELATED APPLICATIONS

The application claims the priority of China Patent Applications No. 202510079116.7, titled “POWER CONVERTER AND ITS CONTROL METHOD,” filed on Jan. 17, 2025, the disclosure of which is incorporated herein by reference.

### FIELD OF THE INVENTION

The present disclosure relates to the technical field of power converting, specifically to dual-transformer type power converters with a wide voltage range and methods for controlling them.

### BACKGROUND OF THE INVENTION

To meet input or output requirements for a wide voltage range, secondary-side switches (such as MOSFETs) of a transformer(s) for a full-bridge converter must withstand higher voltage stress. Also, a dual-transformer full-bridge converter will encounter voltage stress issues with the secondary-side switches. Although some power conversion technologies have been provided in the art, they still need to be improved.

### SUMMARY OF THE INVENTION

One object of the present disclosure is to provide power converters and methods for controlling the same to improve the situation in which secondary-side switches of transformers are subjected to higher voltage stress when a dual-transformer full-bridge converter is used in a wide range of input/output voltage applications.

To achieve the above object, one aspect of the present disclosure provides a power converter, which includes: two transformers, wherein primary sides of the two transformers are connected in series to form a primary series assembly; an input switch assembly including a first bridge arm and a second bridge arm connected in parallel, wherein the first bridge arm includes a first switch and a second switch connected in series to form a first node, the second bridge arm includes a third switch and a fourth switch connected in series to form a second node, and the input switch assembly is configured to operate in a full-bridge mode or a half-bridge mode; wherein the primary series assembly and an input capacitor are connected in series between the first node and the second node; and a control module electrically connected to the input switch assembly; wherein the control module is configured to perform operations including: controlling the third switch and the fourth switch to be turned on and off complementarily; in response to the input switch assembly being switched from the full-bridge mode to the half-bridge mode, controlling a duty cycle of a control signal for the first switch asynchronous with a control signal for the fourth switch to be reduced to zero gradually, and controlling a duty cycle of a control signal for the second switch asynchronous with a control signal for the third switch to be raised to one gradually; and in response to the input switch assembly being switched from the half-bridge mode to the full-bridge mode, controlling the duty cycle of the control signal for the first switch to be raised from zero gradually to make the control signal for the first switch asynchronous with the control signal for the fourth switch, and controlling the duty cycle of the control signal for the second switch to be reduced from one gradually to make the control signal for the second switch asynchronous with the control signal for the third switch, to control the first switch and the second switch to be turned on and off complementarily.

To achieve the above object, another aspect of the present disclosure provides a power converter, which includes: two transformers, wherein primary sides of the two transformers are connected in series to form a primary series assembly; an input switch assembly including a first bridge arm and a second bridge arm connected in parallel, wherein the first bridge arm includes a first switch and a second switch connected in series to form a first node, the second bridge arm includes a third switch and a fourth switch connected in series to form a second node, and the input switch assembly is configured to operate in a full-bridge mode or a half-bridge mode, and the primary series assembly is connected between the first node and the second node; wherein the first node is electrically connected to a third node via a back-to-back switch assembly, and the third node is formed by two input capacitors connected in series; and a control module electrically connected to the input switch assembly and the back-to-back switch assembly; wherein the control module is configured to perform operations including: controlling the third switch and the fourth switch to be turned on and off complementarily; in response to the input switch assembly being switched from the full-bridge mode to the half-bridge mode, controlling a duty cycle of a control signal for the first switch asynchronous with a control signal for the fourth switch to be reduced to zero gradually, controlling a duty cycle of a control signal for the second switch asynchronous with a control signal for the third switch to be reduced to zero gradually, and controlling the back-to-back switch assembly to be turned on; and in response to the input switch assembly being switched from the half-bridge mode to the full-bridge mode, controlling the duty cycle of the control signal for the first switch to be raised from zero gradually to make the control signal for the first switch asynchronous with the control signal for the fourth switch, and controlling the duty cycle of the control signal for the second switch to be raised from zero gradually to make the control signal for the second switch asynchronous with the control signal for the third switch, to control the first switch and the second switch to be turned on and off complementarily, and controlling the back-to-back switch assembly to be turned off.

To achieve the above object, yet another aspect of the present disclosure provides a power converter control method applied to a power converter including two transformers, an input switch assembly, and a control module, wherein primary sides of the two transformers are connected in series to form a primary series assembly, the input switch assembly includes a first bridge arm and a second bridge arm connected in parallel, the first bridge arm includes a first switch and a second switch connected in series to form a first node, and the second bridge arm includes a third switch and a fourth switch connected in series to form a second node, wherein the input switch assembly is configured to operate in a full-bridge mode or a half-bridge mode; wherein in a first configuration, the primary series assembly and an input capacitor are connected in series between the first node and the second node, and the control module is electrically connected to the input switch assembly; or, in a second configuration, the first node is electrically connected to a third node via a back-to-back switch assembly, wherein the third node is formed by two input capacitors connected in series, and the control module is electrically connected to the input switch assembly and the back-to-back switch assembly; wherein the method includes: configuring the control module to perform operations including: controlling the third switch and the fourth switch to be turned on and off complementarily; for the first configuration: in response to the input switch assembly being switched from the full-bridge mode to the half-bridge mode, controlling a duty cycle of a control signal for the first switch asynchronous with a control signal for the fourth switch to be reduced to zero gradually, and controlling a duty cycle of a control signal for the second switch asynchronous with a control signal for the third switch to be raised to one gradually; and in response to the input switch assembly being switched from the half-bridge mode to the full-bridge mode, controlling the duty cycle of the control signal for the first switch to be raised from zero gradually to make the control signal for the first switch asynchronous with the control signal for the fourth switch, and controlling the duty cycle of the control signal for the second switch to be reduced from one gradually to make the control signal for the second switch asynchronous with the control signal for the third switch, to control the first switch and the second switch to be turned on and off complementarily; for the second configuration: in response to the input switch assembly being switched from the full-bridge mode to the half-bridge mode, controlling a duty cycle of a control signal for the first switch asynchronous with a control signal for the fourth switch to be reduced to zero gradually, controlling a duty cycle of a control signal for the second switch asynchronous with a control signal for the third switch to be reduced to zero gradually, and controlling the back-to-back switch assembly to be turned on; and in response to the input switch assembly being switched from the half-bridge mode to the full-bridge mode, controlling the duty cycle of the control signal for the first switch to be raised from zero gradually to make the control signal for the first switch asynchronous with the control signal for the fourth switch, and controlling the duty cycle of the control signal for the second switch to be raised from zero gradually to make the control signal for the second switch asynchronous with the control signal for the third switch, to control the first switch and the second switch to be turned on and off complementarily, and controlling the back-to-back switch assembly to be turned off.

The present disclosure provides power converters and methods for controlling the same, in which the primary sides of the two transformers are connected in series to form the primary series assembly, and the input switch assembly is configured to operate in the full-bridge mode or the half-bridge mode. In the first configuration, the primary series assembly and the capacitor are connected in series between two nodes of the input switch assembly, and the control module is electrically connected to the input switch assembly; alternatively, in the second configuration, one of the nodes of the input switch assembly is electrically connected to a node, which is formed by two input capacitors connected in series, via the back-to-back switch assembly, and the control module is electrically connected to the input switch assembly and the back-to-back switch assembly. In the half-bridge or full-bridge mode, the control module controls the input switch assembly in the first configuration or the input switch assembly and the back-to-back switch assembly in the second configuration to form a half-bridge or full-bridge architecture. In the full-bridge mode, there is a phase shift between control signals of two switches. Thus, it can solve the issue of a dual-transformer power converter in a wide range of input/output voltage applications. Particularly, when the input voltage is high, the voltage stress on electronic switches on the secondary side of the transformers can be significantly reduced.

### BRIEF DESCRIPTION OF THE DRAWINGS

FIG. 1 is a schematic diagram illustrating a circuit of a dual-transformer full-bridge converter associated with the present disclosure.

FIG. 2 is a schematic diagram illustrating a circuit of a first embodiment of a power converter of the present disclosure.

FIG. 3 is a schematic diagram illustrating signals in the circuit, as shown in FIG. 2, operating in a full-bridge mode.

FIG. 4 is a schematic diagram illustrating an equivalent circuit to the circuit, as shown in FIG. 2, operating in a half-bridge mode.

FIG. 5 is a schematic diagram illustrating signals in the circuit, as shown in FIG. 2, operating in the half-bridge mode.

FIG. 6 is a schematic diagram illustrating a waveform of output signals in the circuit, as shown in FIG. 2.

FIG. 7 is a schematic diagram illustrating a circuit of a second embodiment of the power converter.

FIG. 8 is a schematic diagram illustrating signals in the circuit, as shown in FIG. 7, operating in the full-bridge mode.

FIG. 9 is a schematic diagram illustrating an equivalent circuit to the circuit, as shown in FIG. 7, operating in the half-bridge mode.

FIG. 10 is a schematic diagram illustrating signals in the circuit, as shown in FIG. 7, operating in the half-bridge mode.

FIG. 11 is a schematic diagram illustrating a waveform of output signals in the circuit, as shown in FIG. 7.

FIG. 12 is a schematic diagram illustrating a control architecture of the power converter operating in the full-bridge mode provided in an embodiment of the present disclosure.

FIG. 13 is a schematic diagram illustrating a control architecture of the power converter operating in the half-bridge mode provided in an embodiment of the present disclosure.

FIG. 14 is a schematic diagram illustrating a control flowchart for the first embodiment of the power converter of the present disclosure.

FIG. 15 is a schematic diagram illustrating signals in the first embodiment of the power converter, which is switched from the full-bridge mode to the half-bridge mode, as provided in the present disclosure.

FIG. 16 is a schematic diagram illustrating signals in the first embodiment of the power converter, which is switched from the half-bridge mode to the full-bridge mode, as provided in the present disclosure.

FIG. 17 is a schematic diagram illustrating a control flowchart for the second embodiment of the power converter, as provided in the present disclosure.

FIG. 18 is a schematic diagram illustrating signals in the second embodiment of the power converter, which is switched from the full-bridge mode to the half-bridge mode, as provided in the present disclosure.

FIG. 19 is a schematic diagram illustrating signals in the second embodiment of the power converter, which is switched from the half-bridge mode to the full-bridge mode, as provided in the present disclosure.

### THE DETAILED DESCRIPTION OF PREFERRED EMBODIMENTS

For the above and other objects, features, and advantages of the present disclosure to be more obvious and understandable, preferred embodiments in the present disclosure will be provided in detail below, along with the accompanying drawings.

With the rapid development of industries such as information and electric vehicles, charging modules have become indispensable key components. For example, as the demand for electric vehicle endurance increases, the output power of charging modules also increases correspondingly. Battery voltage fluctuates as the state of charge changes in electric vehicles. Accordingly, an auxiliary power module (APM) must be designed to accommodate these changes. Therefore, the APM usually needs a wide range of input voltage to accommodate different battery voltages. For example, the APM may need to operate within the voltage range of a high-voltage battery (such as 200V to 500V or higher) and provide a stable voltage output within the voltage range of a low-voltage battery (such as 6V to 16V or higher). This design of the wide range of input/output voltage ensures that the APM can stably provide the required power to auxiliary equipment under various operating conditions, whether the battery is full or nearly exhausted.

Applying full-bridge converters in APM has significant advantages over related technologies, especially when dealing with a wide range of input or output voltages. In this case, full-bridge converters have high efficiency and good voltage regulation capabilities. They can effectively cope with varying input voltages from high-voltage battery packs while providing stable output voltages. It is critical to ensure that devices function properly under varying operating conditions. In addition, using a full-bridge topology can evenly distribute voltage and current stresses, reduce component losses, and improve system reliability and life. Furthermore, this design also helps achieve high power density, allowing the full-bridge converter to provide efficient power conversion in space-limited APMs, making it an ideal choice for auxiliary power systems for electric vehicles.

It is worth noting that the number of transformer coil turns of the full-bridge converter in the APM will be lower than that of the full-bridge converter that outputs a fixed voltage to meet the wide range of input or output voltage requirements. A lower number of coil turns means that when an input voltage is higher, electronic switches (such as MOSFETs) on the secondary side of a transformer must withstand more voltage stress. Therefore, the withstand voltage level of the electronic switches must be selected to be higher than the specification of the full-bridge converter that outputs a fixed voltage.

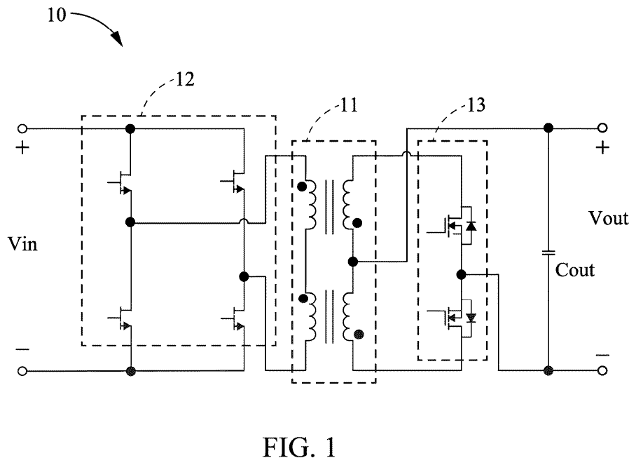

For example, as shown in FIG. 1, a two-transformer full-bridge converter 10 includes a transformer module 11, an input switch assembly 12, and an output switch assembly 13. The transformer module 11 is coupled to the input switch assembly 12 and the output switch assembly 13. The input switch assembly 12 is used to receive an input voltage Vin. The output switch assembly 13 is coupled to the output capacitor Cout to provide an output voltage Vout. Thus, it can realize the advantages of soft-switching on the primary side under a full range of load conditions and does not require the installation of components such as output inductors. However, this architecture still faces an issue of voltage stress on the electronic switches of the secondary side when dealing with a wide range of input/output voltages.

To solve the issue of the dual-transformer full-bridge converter in a wide input/output voltage application, especially when the input voltage is high, the electronic switches on the secondary side of the transformer must withstand more voltage stress. Herein, implementations of a power converter are provided and illustrated below with examples, but they are not limited to the description here.

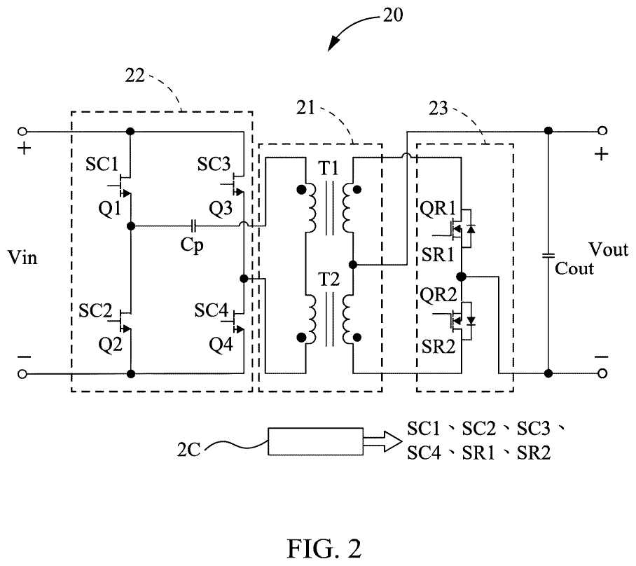

In a first embodiment, FIG. 2 shows a bridge-topological converter with a blocking capacitor. A power converter 20 includes a transformer module 21, an input switch assembly 22, and a control module 2C. The transformer module 21 includes two transformers T1 and T2. Primary sides of the two transformers T1 and T2 are connected in series to form a primary series assembly. Secondary sides of the two transformers T1 and T2 are connected in series to form a secondary series assembly, e.g., dotted terminals are coupled. The input switch assembly 22 can receive an input voltage Vin (such as 200 to 500 Vdc). The input switch assembly 22 includes a first bridge arm and a second bridge arm connected in parallel. The first bridge arm includes a first switch Q1 and a second switch Q2 connected in series to form a first node. The second bridge arm includes a third switch Q3 and a fourth switch Q4 connected in series to form a second node. The first switch Q1, the second switch Q2, the third switch Q3, and the fourth switch Q4 are electronic switches. Herein, MOSFETs are merely used in examples for illustration, but they are not limited to the description here. An input capacitor Cp and the primary series assembly formed by the primary sides of the two transformers T1 and T2 are connected in series between the first and second nodes. In this example, the input capacitor Cp is provided between the first node and the transformer T1 to facilitate blocking inappropriate signal components from the input switch assembly 22 to the transformer module 21. The control module 2C can be a microprocessor (MCU), a digital signal processor (DSP), or an application-specific integrated circuit (ASIC). The control module 2C is electrically connected to the first switch Q1, the second switch Q2, the third switch Q3, and the fourth switch Q4 of the input switch assembly 22 and outputs control signals SC1, SC2, SC3, and SC4 to control the first switch Q1, the second switch Q2, the third switch Q3, and the fourth switch Q4 to operate the input switch assembly 22 in a full-bridge mode or a half-bridge mode.

For example, as shown in FIG. 2, the control module 2C is configured to control the input switch assembly 22 from the full-bridge mode to the half-bridge mode in response to determining that an input voltage Vin associated with the input switch assembly 22 is greater than a voltage threshold (for example, Vin>350 Vdc); the control module 2C is configured to control the input switch assembly 22 from the half-bridge mode to the full-bridge mode in response to determining that an input voltage Vin associated with the input switch assembly 22 is less than or equal to the voltage threshold (for example, Vin<=350 Vdc).

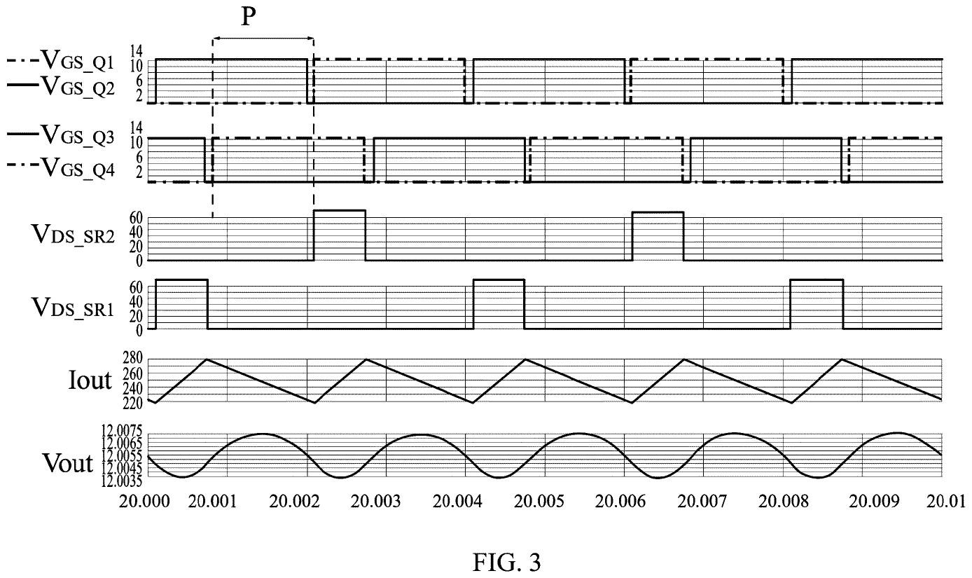

As shown in FIGS. 2 and 3, the control signal SC1 is, for example, a signal V_{GS_Q1} representing a voltage difference between the gate (G) and the source(S) of the first switch Q1; the control signal SC2 is, for example, a signal V_{GS_Q2} representing a voltage difference between the gate and the source of the second switch Q2; the control voltage SC3 is, for example, a signal V_{GS_Q3} representing a voltage difference between the gate and the source of the third switch Q3; the control signal SC4 is, for example, a signal V_{GS_Q4} representing a voltage difference between the gate and the source of the fourth switch Q4. A stress voltage of the fifth switch QR1 on the secondary side of the transformer is, for example, a signal V_{DS_SR1} representing a voltage difference between the drain (D) and the source(S) of the fifth switch QR1. A stress voltage of the sixth switch QR2 on the secondary side of the transformer is, for example, a signal V_{DS_SR2} representing a voltage difference between the drain and the source of the sixth switch QR2. An output voltage Vout corresponds to an output current Iout.

FIGS. 2 and 3 show that when a value representing the input voltage Vin is relatively low (such as Vin<350 Vdc), the input switch assembly 22 operates in a full-bridge phase shift mode. For example, the control module 2C is configured to perform operations, including: in response to the input switch assembly being switched from the half-bridge mode to the full-bridge mode, controlling a duty cycle of the control signal SC1 for the first switch Q1 to be raised from zero (i.e., 0%) gradually to make the control signal SC1 for the first switch Q1 asynchronous with the control signal SC4 for the fourth switch Q4, and controlling a duty cycle of the control signal SC2 for the second switch Q2 to be reduced from one (i.e., 100%) gradually to make the control signal SC2 for the second switch Q2 asynchronous with the control signal SC3 for the third switch Q3. The first switch Q1 and the second switch Q2 are controlled to be turned on and off complementarily. For example, the control signal SC1 of the first switch Q1 (e.g., V_{GS_Q1}, as shown in FIG. 3) and control signal SC2 of the second switch Q2 (e.g., V_{GS_Q2}, as shown in FIG. 3) is 50% (i.e., 0.5) or its increased/decreased values. In addition, the third switch Q3 and the fourth switch Q4 are controlled to turn on and off complementarily. For example, a duty cycle of the control signal SC3 of the third switch Q3 (e.g., V_{GS_Q3}, as shown in FIG. 3) and the control signal SC4 of the fourth switch Q4 (e.g., V_{GS_Q4}, as shown in FIG. 3) can be 50% (i.e., 0.5) or its increased/decreased values. Furthermore, there is a phase shift P between the control signal SC1 of the first switch Q1 (e.g., V_{Gs_Q1} shown in FIG. 3) and the control signal SC4 of the fourth switch Q4 (e.g., V_{GS_Q4} shown in FIG. 3), such as the phase shift P being set within a phase shift range, which is greater than 0 degree and not more than 180 degrees, such as 45 degrees, 90 degrees, or 135 degrees.

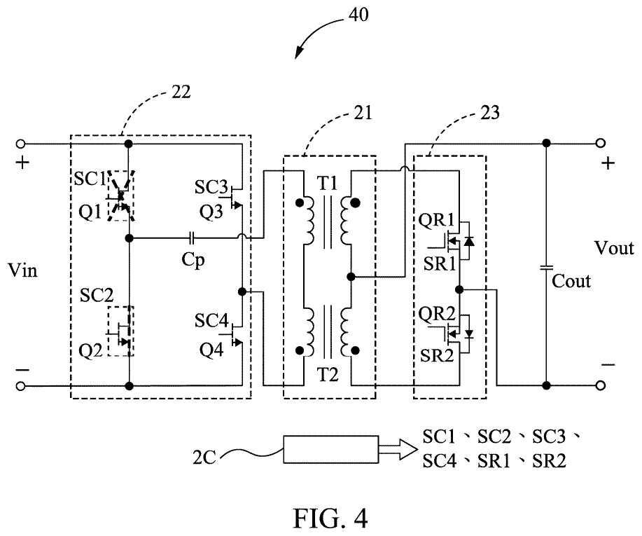

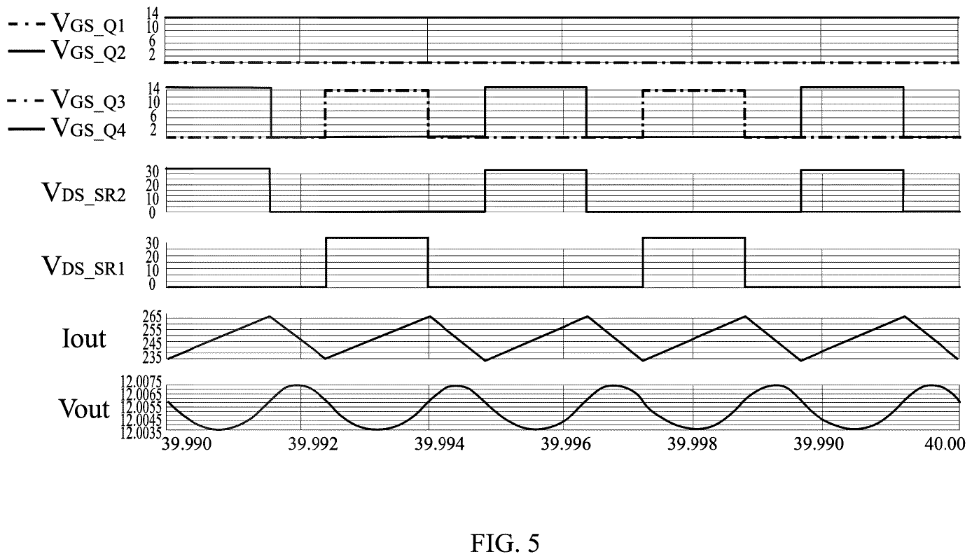

FIGS. 4 and 5 show that when a value representing the input voltage Vin of a power converter 40 is relatively high (such as Vin>350 Vdc), the input switch assembly 22 operates in the half-bridge mode. For example, the control module 2C is configured to perform operations, including: in response to the input switch assembly being switched from the full-bridge mode to the half-bridge mode, controlling the third switch Q3 and the fourth switch Q4 to be turned on and off complementarily; controlling the duty cycle (e.g., 50% that is 0.5) of the control signal SC1 (e.g., V_{GS_Q1}, as shown in FIGS. 3 and 5) for the first switch Q1 asynchronous with the control signal SC4 (e.g., V_{GS_Q4}, as shown in FIGS. 3 and 5) for the fourth switch Q4 to be reduced to zero (e.g., 0% that is a low level of a PWM signal) gradually to make the first switch Q1 gradually equivalent to being turned off in a full-time manner, and controlling the duty cycle (e.g., 50% that is 0.5) of the control signal SC2 (e.g., V_{GS_Q2}, as shown in FIGS. 3 and 5) for the second switch Q2 asynchronous with the control signal SC3 (e.g., V_{GS_Q3}, as shown in FIGS. 3 and 5) for the third switch Q3 to be raised to one (e.g., 100% that is a high level of the PWM signal) gradually to make the second switch Q2 gradually equivalent to being turned on in a full-time manner.

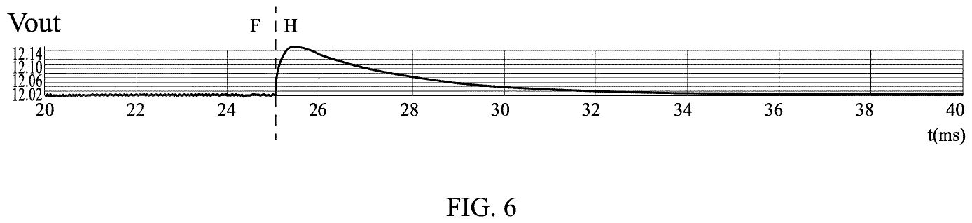

In addition, as shown in FIG. 2, the power converter 20 also includes an output switch assembly 23. The output switch assembly 23 is connected to the secondary series assembly of the transformer module 21 in parallel, and the control module 2C is electrically connected to the output switch assembly 23. For example, the secondary sides of the two transformers T1 and T2 are connected to form a first contact. The output switch assembly 23 includes a fifth switch QR1 and a sixth switch QR2 connected in series. The fifth switch QR1 and the sixth switch QR2 are connected to form a second contact. An output capacitor Cout is electrically connected between the first and the second contacts. The control module 2C is electrically connected to the fifth switch QR1 and the sixth switch QR2 of the output switch assembly 23. The control module 2C outputs control signals SR1 and SR2 to control the fifth switch QR1 and the sixth switch QR2, causing the output capacitor Cout to generate the output voltage Vout. As shown in FIG. 6, in the first embodiment of the power converter, when the full-bridge mode (or full-bridge stage, shown as F in FIG. 6) is converted to the half-bridge mode (or half-bridge stage, shown as “H” in FIG. 6) , an input voltage is 480 Vdc, an output voltage is 12 Vdc, and an output power is 3 kW.

It can be seen from FIGS. 3 and 5, as provided below. The voltage stress (such as V_{DS_SR1}) of the fifth switch connected to the secondary side of the transformer is reduced from 79.017 Vdc (as shown in FIG. 3) to 39.8721 Vdc (as shown in FIG. 5). The voltage stress (such as V_{DS_SR2}) of the sixth switch connected to the secondary side of the transformer is reduced from 79.0379 Vdc (as shown in FIG. 3) to 39.8924 Vdc (as shown in FIG. 5). The ripple of the output current Iout corresponding to the output voltage Vout drops from 62.483 Adc (as shown in FIG. 3) to 32.6985 Adc (as shown in FIG. 5). The output ripple current (Iout_pp, peak-to-peak output current) drops from the original 62.5 Adc to 32.2 Adc. Therefore, the voltage stress of the electronic switches on the secondary sides of the transformers of the first embodiment of the power converter can be significantly reduced.

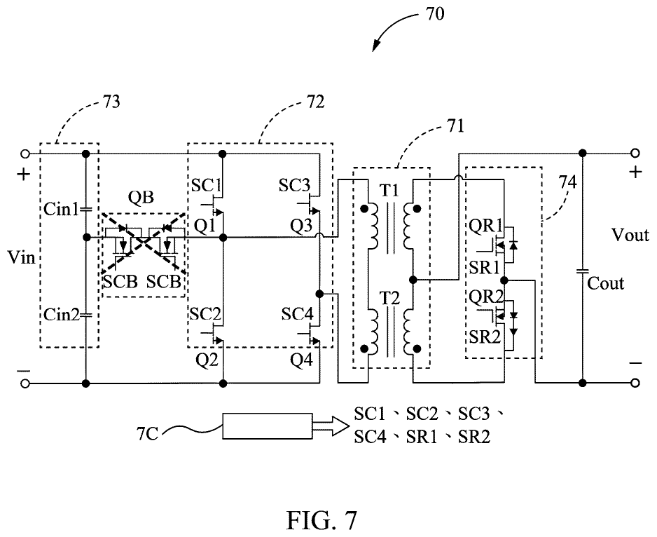

In a second embodiment, FIG. 7 shows a bridge-topological converter with a back-to-back switch assembly. A power converter 70 includes a transformer module 71, an input switch assembly 72, and a control module 7C. The transformer module 71, the input switch assembly 72, and the control module 7C are essentially the same as the transformer module 21, the input switch assembly 22, and the control module 2C. For example, the transformer module 71 includes two transformers T1 and T2. The primary sides of the two transformers T1 and T2 are connected in series to form a primary series assembly, and the secondary sides of the two transformers T1 and T2 are connected in series to form a secondary series assembly. The input switch assembly 72 can receive an input voltage Vin (such as 200 to 500 Vdc). The input switch assembly 72 includes a first bridge arm and a second bridge arm connected in parallel. The first bridge arm includes a first switch Q1 and a second switch Q2 connected in series to form a first node. The second bridge arm includes a third switch Q3 and a fourth switch Q4 connected in series to form a second node. The first node is electrically connected to a third node formed by two input capacitors Cin1 and Cin2 in series, via a back-to-back switch assembly QB. In this example, the two input capacitors Cin1 and Cin2 are connected in series to form an input capacitor assembly 73 for receiving the input voltage Vin. The input capacitor assembly 73 is connected to the input switch assembly 72 in parallel. The control module 7C is electrically connected to the first switch Q1, the second switch Q2, the third switch Q3, and the fourth switch Q4 of the input switch assembly 72 and the back-to-back switch assembly QB and outputs control signals SC1, SC2, SC3, SC4, and SCB to control the first switch Q1, the second switch Q2, the third switch Q3, the fourth switch Q4, and the back-to-back switch assembly QB to operate the input switch assembly 72 in a full-bridge mode or a half-bridge mode.

For example, as shown in FIG. 7, the control module 7C is configured to control the input switch assembly 72 to be switched from the full-bridge mode to the half-bridge mode in response to determining that a value representing the input voltage Vin associated with the input switch assembly 72 is greater than a voltage threshold (e.g., Vin>350 Vdc). Also, the control module 7C is configured to control the input switch assembly 72 to be switched from the half-bridge mode to the full-bridge mode in response to determining that the value representing the input voltage Vin is less than or equal to the voltage threshold (for example, Vin<=350 Vdc).

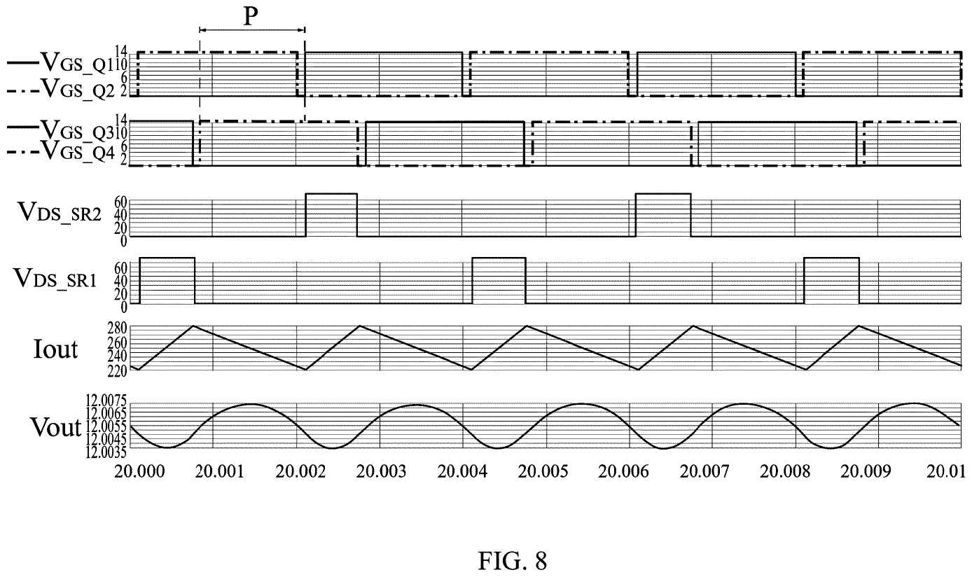

As shown in FIGS. 7 and 8, when the value representing the input voltage Vin is relatively low (such as Vin<=350 Vdc), the input switch assembly 72 operates in a full-bridge phase shift mode. For example, the control module 7C is configured to perform operations, including: in response to the input switch assembly 72 being switched from the half-bridge mode to the full-bridge mode, controlling the duty cycle of the control signal SC1 for the first switch Q1 to be raised from zero gradually to make the control signal SC1 for the first switch Q1 asynchronous with the control signal SC4 for the fourth switch Q4, and controlling the duty cycle of the control signal SC2 for the second switch Q2 to be raised from zero gradually to make the control signal SC2 for the second switch Q2 asynchronous with the control signal SC3 for the third switch Q3, to control the first switch Q1 and the second switch Q2 to be turned on and off complementarily. For example, the control signal SC1 of the first switch Q1 (e.g., V_{GS_Q1}, as shown in FIG. 8) and control signal SC2 of the second switch Q2 (e.g., V_{GS_Q2}, as shown in FIG. 8) is 50% (i.e., 0.5) or its increased/decreased values. In addition, the third switch Q3 and the fourth switch Q4 are controlled to turn on and off complementarily. For example, a duty cycle of the control signal SC3 of the third switch Q3 (e.g., V_{GS_Q3}, as shown in FIG. 8) and the control signal SC4 of the fourth switch Q4 (e.g., V_{GS_Q4}, as shown in FIG. 8) can be 50% (i.e., 0.5) or its increased/decreased values. Furthermore, the back-to-back switch assembly QB is controlled to be turned off. For example, a duty cycle of the control signal SCB for the back-to-back switch assembly QB is set to zero to make the back-to-back switch assembly QB equivalent to being turned off in a full-time manner. Moreover, there is a phase shift P between the control signal SC1 of the first switch Q1 (e.g., V_{GS_Q1} shown in FIG. 8) and the control signal SC4 of the fourth switch Q4 (e.g., V_{GS_Q4} shown in FIG. 8), such as the phase shift P being set within a phase shift range, which is greater than 0 degree and not more than 180 degrees, such as 45 degrees, 90 degrees, or 135 degrees.

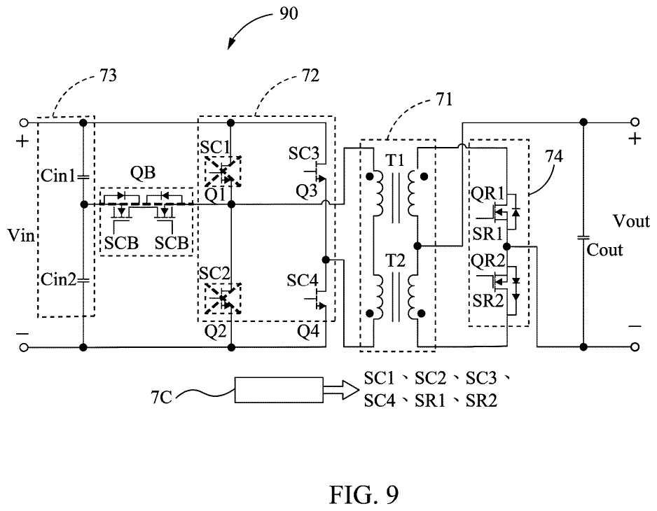

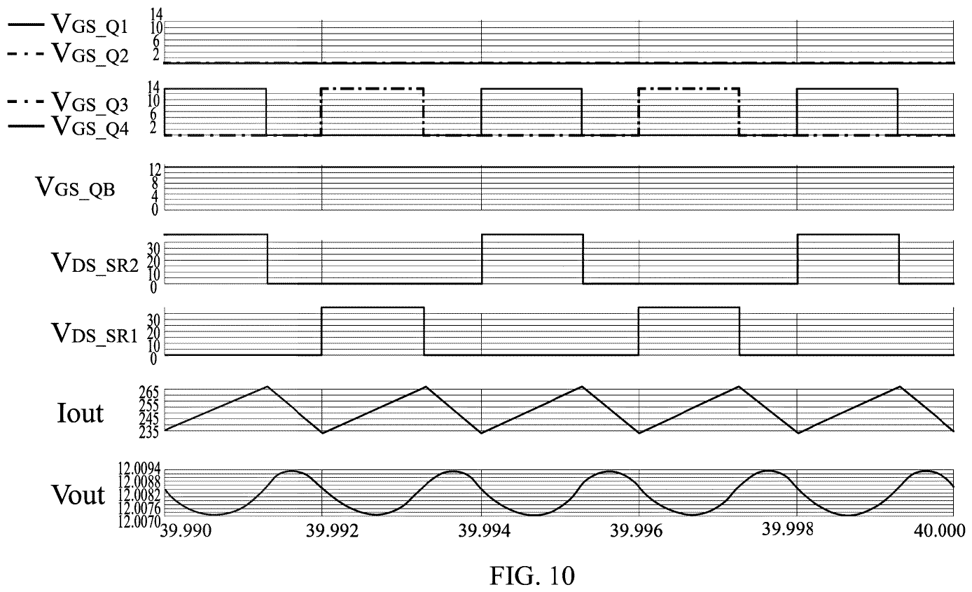

As shown in FIGS. 9 and 10, the control signal SCB is, for example, a signal V_{GS_QB} representing a voltage difference between the gate and the source of the back-to-back switch assembly QB. When the value representing the input voltage Vin of the power converter 90 is relatively high (such as Vin>350 Vdc), the input switch assembly 72 operates in the half-bridge mode. For example, in response to the input switch assembly 72 being switched from the full-bridge mode to the half-bridge mode, controlling the third switch Q3 and the fourth switch Q4 to be turned on and off complementarily, controlling a duty cycle (e.g., 50%, that is equal to 0.5) of a control signal SC1 for the first switch Q1 asynchronous with a control signal SC4 for the fourth switch Q4 to be reduced to zero (e.g., 0%, that is a low level of a PWM signal) gradually to make the first switch Q1 gradually equivalent to being turned off in a full-time manner, controlling a duty cycle (e.g., 50%, that is equal to 0.5) of a control signal SC2 for the second switch Q2 asynchronous with a control signal SC3 for the third switch Q3 to be reduced to zero gradually to make the second switch Q2 gradually equivalent to being turned off in a full-time manner. In addition, the back-to-back switch assembly QB is controlled to be turned on. For example, the duty cycle of the control signal SCB of the back-to-back switch assembly QB is set to 100% (i.e., equal to 1, which is a high level of the PWM signal) so that the back-to-back switch assembly QB is equivalent to being turned on in a full-time manner.

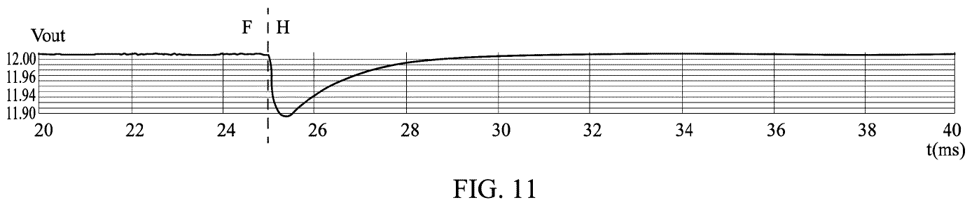

In addition, as shown in FIG. 7, the power converter 70 further includes an output switch assembly 74 and an output capacitor Cout. The output switch assembly 74 is connected to the secondary series assembly of the transformer module 71 in parallel. The control module 7C is electrically connected to the output switch assembly 74. For example, the secondary sides of the two transformers T1 and T2 are connected to form a first contact. The output switch assembly 74 includes a fifth switch QR1 and a sixth switch QR2 connected in series to form a second contact. The first contact and the second contact are electrically connected to the output capacitor Cout. The control module 7C is electrically connected to the fifth switch QR1 and the sixth switch QR2 of the output switch assembly 74 and outputs control signals SR1 and SR2 to control the fifth switch QR1 and the sixth switch QR2, causing the output capacitor Cout to generate the output voltage Vout. As shown in FIG. 11. in the second embodiment of the power converter, when the full-bridge mode (or full-bridge stage, shown as F in FIG. 11) is converted to the half-bridge mode (or half-bridge stage, shown as H in FIG. 11), an input voltage is 480 Vdc, an output voltage is 12 Vdc, and an output power is 3 kW.

It can be seen from FIGS. 8 and 10 that the voltage stress (such as V_{DS_SR1}) of the fifth switch connected to the secondary side of the transformer is reduced from 79.0172 Vdc (as shown in FIG. 8) to 39.072 Vdc (as shown in FIG. 10). The voltage stress (such as V_{DS_SR2}) of the sixth switch connected to the secondary side of the transformer is reduced from 79.0379 Vdc (as shown in FIG. 8) to 39.082 Vdc (as shown in FIG. 10). The ripple of the output current Iout corresponding to the output voltage Vout is reduced from 62.488 Adc (as shown in FIG. 8) to 32.188 Adc (as shown in FIG. 10). The output ripple current (Iout_pp) drops from the original 62.5 Adc to 32.2 Adc. Therefore, the voltage stress of the electronic switches on the secondary sides of the transformers of the second embodiment of the power converter can be significantly reduced.

The following examples illustrate a control architecture in the first and second embodiments of the power converter.

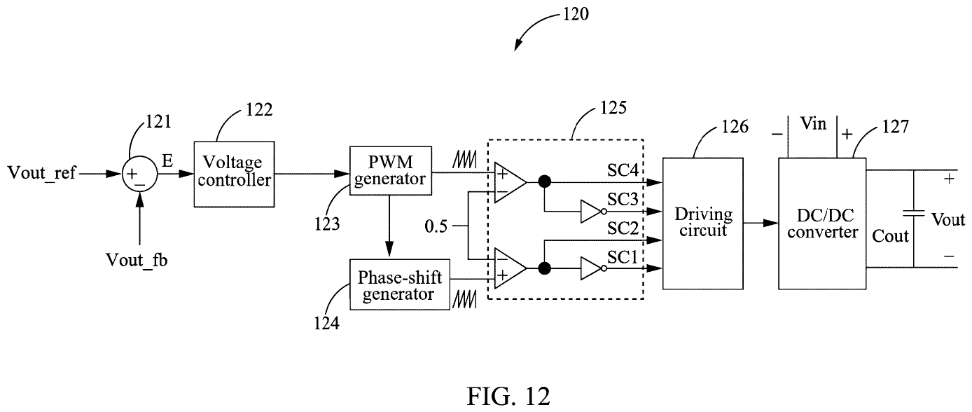

In one aspect, in response to the input switch assembly being in the full-bridge mode, as shown in FIG. 12, a control architecture example 120 includes a subtractor 121, a voltage controller 122, a PWM generator 123, a phase shift generator 124, and a complementary signal generator 125, a driving circuit 126, and a DC converter (such as a DC/DC converter) 127. The DC converter 127 can be, for example, the power converter 20 in FIG. 2 or the power converter 70 in FIG. 7. Taking the power converter 20 as an example, the DC converter 127 may receive the input voltage Vin and generate the output voltage Vout from the output capacitor Cout. The output voltage Vout can be captured as a feedback voltage value Vout_fb. The subtractor 121 can subtract the feedback voltage value Vout_fb from a voltage reference value Vout_ref to calculate a voltage error value E. The voltage error value E can be used by the voltage controller 122 (such as a PI controller) to generate a control value. The control value can be used by the PWM generator 123 to generate a pulse width modulation (PWM) signal with a specific duty cycle. The phase shift generator 124 can use the PWM signal to generate a phase shift. The pulse width modulation signal and the phase shift are used by the complementary signal generator 125 to generate the control signals SC1, SC2, SC3, and SC4 based on the reference value of 0.5 (i.e., 50%). The control signals SC1, SC2, SC3, and SC4 are input signals of the driving circuit 126 for generating a driving signal to the DC converter 127 to ensure the DC converter 127 operating in the full-bridge mode.

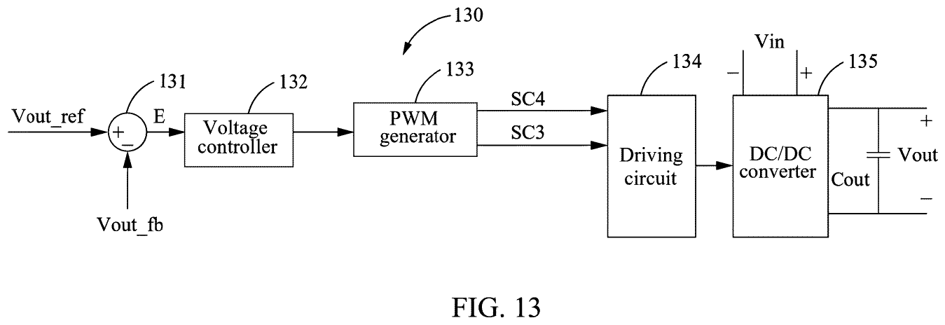

In another aspect, because the input switch assembly is in the half-bridge mode, as shown in FIG. 13, a control architecture example 130 includes a subtractor 131, a voltage controller 132, a PWM generator 133, a driving circuit 134, and a DC converter (such as a DC/DC converter) 135. The DC converter 135 may be, for example, the power converter 20 in FIG. 2 or the power converter 70 in FIG. 7. Taking the power converter 20 as an example, the DC converter 135 may receive the input voltage Vin, and the output voltage Vout is generated by the output capacitor Cout. The output voltage Vout can be captured as a feedback voltage value Vout_fb. The subtractor 131 can subtract the feedback voltage value Vout_fb from a voltage reference value Vout_ref to calculate a voltage error value E. The voltage error value E can be used by the controller 132 (such as a PI controller) to generate a control quantity. The control quantity can be used by the PWM generator 133 to generate a pulse width modulation (PWM) signal with a specific duty cycle as the control signals SC3 and SC4, which are used as the input signal of the drive circuit 134 for generating a driving signal to the DC converter 135 to ensure the DC converter 135 operating in the half-bridge mode.

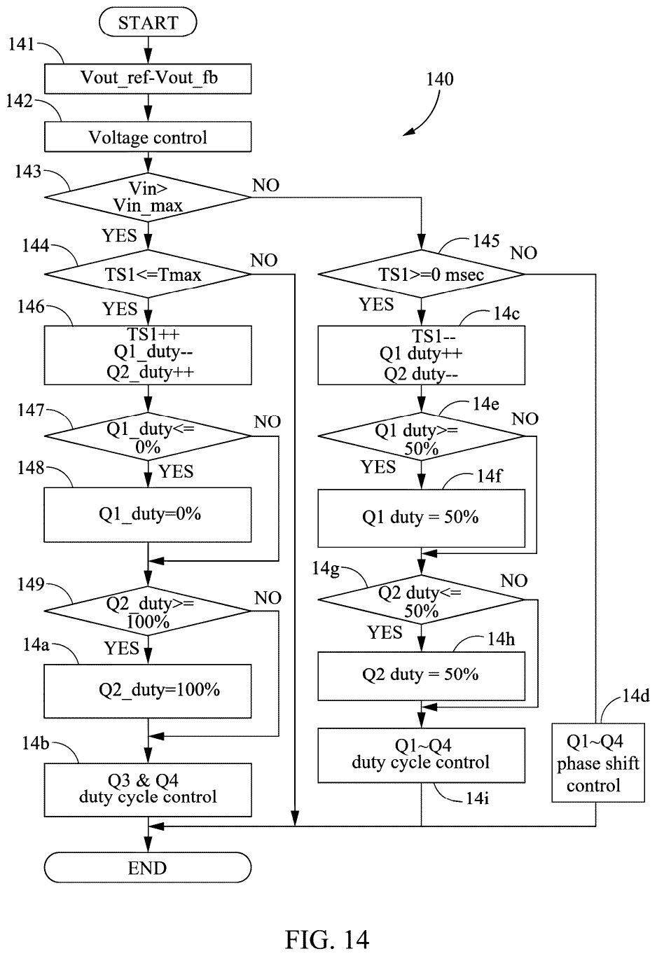

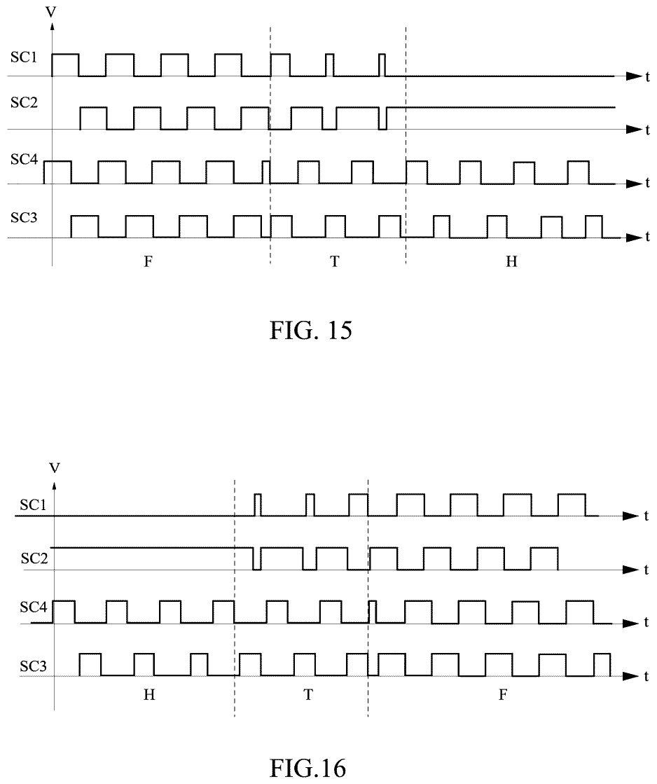

A control process of the first embodiment of the power converter is illustrated in the following example. As shown in FIGS. 2 and 12 to 14, a process example 140 includes steps as follows. In step 141, the control module 2C reads the output voltage Vout as the feedback voltage value Vout_fb and subtracts the feedback voltage value Vout_fb from the voltage reference value Vout_ref to calculate the voltage error value E. In step 142, the voltage controller generates a control value based on the voltage error value E, and next, proceed to step 143. In step 143, it is determined whether the input voltage Vin is greater than a preset input maximum value Vin_max (such as the voltage threshold); if the determination results in YES, the power converter is switched from the full-bridge mode to the half-bridge mode, and next, proceed to step 144; if the determination results in NO, the power converter is switched from the half-bridge mode to the full-bridge mode, and next, proceed to step 145. In step 144, it is determined whether a switching time (such as TS1) is less than or equal to a maximum switching time (such as Tmax); if the determination results in YES, proceed to step 146; if the determination results in NO, the switching time (such as TS1) has reached the maximum value, the switching time (such as TS1) remains unchanged, and the control process goes to END. In step 146, the switching time (such as TS1) gradually increases, and the duty cycle of the first switch Q1 (such as Q1_duty) gradually decreases to 0% (as shown in FIG. 15, the duty cycle of the control signal SC1 gradually decreases to 0%, going from the full-bridge stage F to the half-bridge stage H through the switching stage T), and the duty cycle of the second switch Q2 (such as Q2_duty) gradually increases to 100% (as shown in FIG. 15, the duty cycle of the signal SC2 gradually increases to 100%, going from the full-bridge stage F to the half-bridge stage H through the switching stage T). Next, proceed to step 147, it is determined whether the duty cycle (Q1_duty) of the first switch Q1 is less than 0%; if the determination results in YES, proceed to step 148; if the determination results in NO, proceed to step 149. In step 148, the duty cycle (Q1_duty) of the first switch Q1 is set to equal 0%. In step 149, it is determined whether the duty cycle (Q1_duty) of the first switch Q1 is greater than 100%; if the determination results in YES, proceed to step 14a; if the determination results in NO, proceed to step 14b. In step 14a, the duty cycle (Q2_duty) of the second switch Q2 is set to equal 100%. In step 14b, the duty cycles are controlled to ensure the third switch Q3 and the fourth switch Q4 are turned on and off in a complementary manner (as shown in FIG. 15, the duty cycle of the control signals SC3 and SC4 are complementary, going from the full-bridge stage F to the half-bridge stage H through the switching stage T). In step 145, it is determined whether the switching time (such as TS1) is greater than or equal to 0 (milliseconds, marked as ms or msec); if the determination results in YES, proceed to step 14c; if the determination results in NO, proceed to step 14d. In step 14c, the switching time (such as TS1) gradually decreases, the duty cycle (Q1_duty) of the first switch Q1 gradually increases to 50% (as shown in FIG. 16, the duty cycle of the control signal SC1 gradually increases to 50%, going from the half-bridge stage H to the full-bridge stage F through the switching stage T), the duty cycle (Q2_duty) of the second switch Q2 gradually reduces to 50% (as shown in FIG. 16, the duty cycle of the control signal SC2 gradually reduces to 50%, going from the half-bridge stage H to the full-bridge stage F through the switching stage T); next, proceed to the steps 14e. In step 14d, the first switch Q1, the second switch Q2, the third switch Q3, and the fourth switch Q4 are changed to a phase shift control mode, e.g., there is the phase shift between the control signals for the first switch Q1 and the fourth switch Q4 (as shown in FIG. 16, the control signals SC1, SC2, SC3, and SC4 go from the half-bridge stage H, through the switching stage T, to the full-bridge stage F, in which there is the phase shift between the control signals SC1 and SC4). In step 14e, it is determined whether the duty cycle (Q1_duty) of the first switch Q1 is greater than or equal to 50%; if the determination results in YES, proceed to step 14 f; if the determination results in NO, proceed to step 14g. In step 14f, the duty cycle (Q1_duty) of the first switch Q1 is set to equal 50%. In step 14g, it is determined whether the duty cycle (Q2_duty) of the second switch Q2 is less than or equal to 50%; if the determination results in YES, proceed to step 14h; if the determination results in NO, proceed to step 14i. In step 14h, the duty cycle (Q2_duty) of the second switch Q2 is set to equal 50%. In step 14i, the duty cycles are controlled to ensure that the first switch Q1 and the second switch Q2 are complementarily turned on and off, and the third switch Q3 and the fourth switch Q4 are turned on and off in a complementary manner (as shown in FIG. 16, the control signals SC1 and SC4 are complementary in the duty cycle, and the control signals SC2 and SC3 are complementary in the duty cycle, going from the half-bridge stage H to the full-bridge stage F through the switching stage T). In graphs of the present disclosure, t represents time and V represents a voltage signal(s). It should be understood that the control module can also appropriately control the fifth and sixth switches on the secondary sides of the transformers to provide an output rectification function. For example, the fifth and sixth switches can be switches with rectification functions or diodes (not limited here) so that the output capacitor generates an output voltage.

As mentioned above, a method embodiment for controlling the first embodiment of the power converter is illustrated below, but it is not limited to the description here. A power converter control method which is applied to a power converter. The power converter includes two transformers, an input switch assembly, and a control module, wherein primary sides of the two transformers are connected in series to form a primary series assembly, the input switch assembly includes a first bridge arm and a second bridge arm connected in parallel, the first bridge arm includes a first switch and a second switch connected in series to form a first node, and the second bridge arm includes a third switch and a fourth switch connected in series to form a second node, wherein the input switch assembly is configured to operate in a full-bridge mode or a half-bridge mode; wherein the primary series assembly and an input capacitor are connected in series between the first node and the second node, and the control module is electrically connected to the input switch assembly. The method includes configuring the control module to perform operations including controlling the third switch and the fourth switch to be turned on and off complementarily; in response to the input switch assembly being switched from the full-bridge mode to the half-bridge mode, controlling a duty cycle of a control signal for the first switch asynchronous with a control signal for the fourth switch to be reduced to zero gradually, and controlling a duty cycle of a control signal for the second switch asynchronous with a control signal for the third switch to be raised to one gradually; and in response to the input switch assembly being switched from the half-bridge mode to the full-bridge mode, controlling the duty cycle of the control signal for the first switch to be raised from zero gradually to make the control signal for the first switch asynchronous with the control signal for the fourth switch, and controlling the duty cycle of the control signal for the second switch to be reduced from one gradually to make the control signal for the second switch asynchronous with the control signal for the third switch, to control the first switch and the second switch to be turned on and off complementarily. This method embodiment is associated with the relevant content of the above-mentioned first embodiment of the power converter and will not be described again.

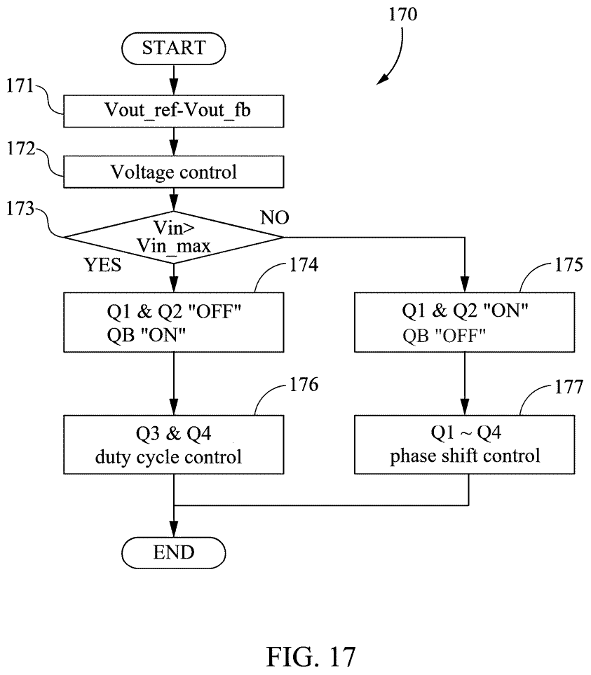

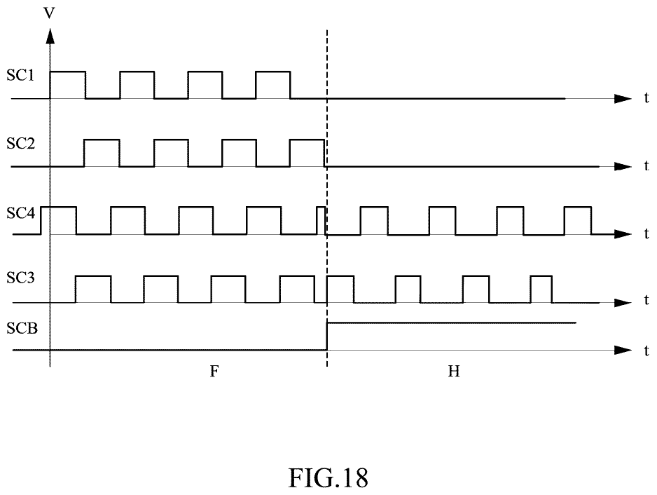

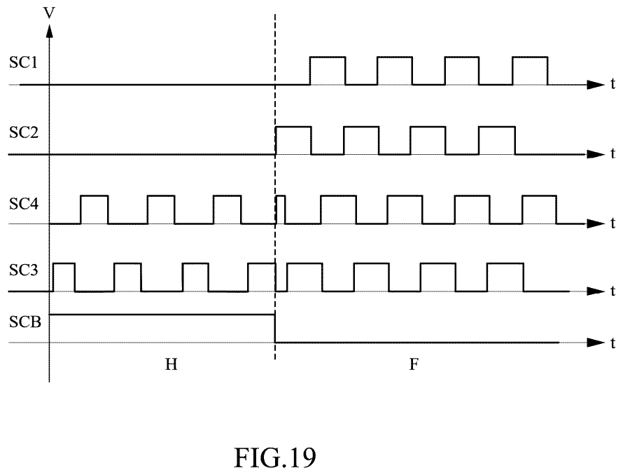

A control process of the second embodiment of the power converter is illustrated in the following example. As shown in FIGS. 7, 12, 13, and 17. A process example 170 includes steps as follows. In step 171, the control module 7C reads the output voltage Vout as the feedback voltage value Vout_fb and subtracts the feedback voltage value Vout_fb from the voltage reference value Vout_ref to calculate the voltage error value E. In step 172, the voltage controller generates a control value based on the voltage error value E, and next, proceed to step 173. In step 173, it is determined whether the input voltage Vin is greater than a preset input maximum value Vin_max (such as the voltage threshold); if the determination results in YES, the power converter is switched from the full-bridge mode to the half-bridge mode, and next, proceed to step 174; if the determination results in NO, the power converter is switched from the half-bridge mode to the full-bridge mode, and next, proceed to step 175. In step 174, the control signals are generated to turn off the first switch Q1 and the second switch Q2, and turn on the back-to-back switch assembly QB (as shown in FIG. 18, the duty cycle of the control signals SC1 and SC2 are set to equal 0 at the change from the full-bridge stage F to the half-bridge stage H), and next, proceed to step 176. In step 176, the duty cycles are controlled to ensure that the third switch Q3 and the fourth switch Q4 are complementarily on and off (as shown in FIG. 18, the control signals SC3 and SC4 are complementary, going from the full-bridge stage F to the half-bridge stage H). In step 175, the control signals are generated to ensure that the first switch Q1 and the second switch Q2 are turned on and the back-to-back switch assembly QB is turned off (as shown in FIG. 19, the control signals SC1 and SC2 are complementary in the duty cycle, and the duty cycle of the control signal SCB of the back-to-back switch assembly QB is set to equal 0 at the change from the half-bridge stage H to the full-bridge stage F); next, proceed to step 177. In step 177, the first switch Q1, the second switch Q2, the third switch Q3, and the fourth switch Q4 are switched to a phase shift control mode, e.g., there is a phase shift between the control signals for the first switch Q1 and the fourth switch Q4 (as shown in FIG. 19, the control signals SC1, SC2, SC3, and SC4 are changed from the half-bridge stage H to the full-bridge stage F, in which there is the phase shift between the control signals SC1 and SC4). It should be understood that the control module can also appropriately control the fifth and sixth switches on the secondary sides of the transformers to provide an output rectification function. For example, the fifth and sixth switches can be switches with rectification functions or diodes (not limited here) so that the output capacitor generates an output voltage.

As mentioned above, the method embodiment for controlling the second embodiment of the power converter is illustrated below, but it is not limited to the description here. A control method for a power converter is applied to a power converter. The power converter includes two transformers, an input switch assembly, and a control module, wherein primary sides of the two transformers are connected in series to form a primary series assembly, the input switch assembly includes a first bridge arm and a second bridge arm connected in parallel, the first bridge arm includes a first switch and a second switch connected in series to form a first node, and the second bridge arm includes a third switch and a fourth switch connected in series to form a second node, wherein the input switch assembly is configured to operate in a full-bridge mode or a half-bridge mode; wherein the first node is electrically connected to a third node via a back-to-back switch assembly, wherein the third node is formed by two input capacitors connected in series, and the control module is electrically connected to the input switch assembly and the back-to-back switch assembly. The method includes configuring the control module to perform operations, including: controlling the third switch and the fourth switch to be turned on and off complementarily; in response to the input switch assembly being switched from the full-bridge mode to the half-bridge mode, controlling a duty cycle of a control signal for the first switch asynchronous with a control signal for the fourth switch to be reduced to zero gradually, controlling a duty cycle of a control signal for the second switch asynchronous with a control signal for the third switch to be reduced to zero gradually, and controlling the back-to-back switch assembly to be turned on; and in response to the input switch assembly being switched from the half-bridge mode to the full-bridge mode, controlling the duty cycle of the control signal for the first switch to be raised from zero gradually to make the control signal for the first switch asynchronous with the control signal for the fourth switch, and controlling the duty cycle of the control signal for the second switch to be raised from zero gradually to make the control signal for the second switch asynchronous with the control signal for the third switch, to control the first switch and the second switch to be turned on and off complementarily, and controlling the back-to-back switch assembly to be turned off. This method embodiment is associated with the relevant content of the above-mentioned second embodiment of the power converter and will not be described again.

The present disclosure further provides a control method for the power converter by comprehensively applying the above two methods. An example is given below, but the method is not limited to the description here. A power converter control method applied to a power converter including two transformers, an input switch assembly, and a control module, wherein primary sides of the two transformers are connected in series to form a primary series assembly, the input switch assembly includes a first bridge arm and a second bridge arm connected in parallel, the first bridge arm includes a first switch and a second switch connected in series to form a first node, and the second bridge arm includes a third switch and a fourth switch connected in series to form a second node, wherein the input switch assembly is configured to operate in a full-bridge mode or a half-bridge mode; wherein in a first configuration, the primary series assembly and an input capacitor are connected in series between the first node and the second node, and the control module is electrically connected to the input switch assembly; or, in a second configuration, the first node is electrically connected to a third node via a back-to-back switch assembly, wherein the third node is formed by two input capacitors connected in series, and the control module is electrically connected to the input switch assembly and the back-to-back switch assembly; wherein the method includes: configuring the control module to perform operations including: controlling the third switch and the fourth switch to be turned on and off complementarily; for the first configuration: in response to the input switch assembly being switched from the full-bridge mode to the half-bridge mode, controlling a duty cycle of a control signal for the first switch asynchronous with a control signal for the fourth switch to be reduced to zero gradually, and controlling a duty cycle of a control signal for the second switch asynchronous with a control signal for the third switch to be raised to one gradually; and in response to the input switch assembly being switched from the half-bridge mode to the full-bridge mode, controlling the duty cycle of the control signal for the first switch to be raised from zero gradually to make the control signal for the first switch asynchronous with the control signal for the fourth switch, and controlling the duty cycle of the control signal for the second switch to be reduced from one gradually to make the control signal for the second switch asynchronous with the control signal for the third switch, to control the first switch and the second switch to be turned on and off complementarily; for the second configuration: in response to the input switch assembly being switched from the full-bridge mode to the half-bridge mode, controlling a duty cycle of a control signal for the first switch asynchronous with a control signal for the fourth switch to be reduced to zero gradually, controlling a duty cycle of a control signal for the second switch asynchronous with a control signal for the third switch to be reduced to zero gradually, and controlling the back-to-back switch assembly to be turned on; and in response to the input switch assembly being switched from the half-bridge mode to the full-bridge mode, controlling the duty cycle of the control signal for the first switch to be raised from zero gradually to make the control signal for the first switch asynchronous with the control signal for the fourth switch, and controlling the duty cycle of the control signal for the second switch to be raised from zero gradually to make the control signal for the second switch asynchronous with the control signal for the third switch, to control the first switch and the second switch to be turned on and off complementarily, and controlling the back-to-back switch assembly to be turned off. In the present embodiment, the control module is configured to receive at least one command instructing the power converter to be configured for the first configuration or the second configuration. In some applications, the power converter may have a first configuration and/or a second configuration, and the switching between the first configuration and the second configuration may be performed by using a plurality of switches to switch to different input switch assemblies and their front-end circuits (such as the back-to-back switch assembly and an input capacitor(s)), implementations of which can be understood by those ordinarily skilled in the art to which the present disclosure belongs. Embodiments of the method are associated with the relevant content of the abovementioned first and second embodiments of the power converter and will not be described again.

The above embodiments of the present disclosure provide power converters and methods for controlling the same, in which the primary sides of the two transformers are connected in series to form the primary series assembly, and the input switch assembly is configured to operate in the full-bridge mode or the half-bridge mode. In the first configuration, the primary series assembly and the capacitor are connected in series between two nodes of the input switch assembly, and the control module is electrically connected to the input switch assembly; alternatively, in the second configuration, one of the nodes of the input switch assembly is electrically connected to a node, which is formed by two input capacitors connected in series, via the back-to-back switch assembly, and the control module is electrically connected to the input switch assembly and the back-to-back switch assembly. In the half-bridge or full-bridge mode, the control module controls the input switch assembly in the first configuration or the input switch assembly and the back-to-back switch assembly in the second configuration to form a half-bridge or full-bridge architecture. In the full-bridge mode, there is a phase shift between control signals of two switches. Thus, it can solve the issue of a dual-transformer power converter in a wide range of input/output voltage applications. Particularly, when the input voltage is high, the voltage stress on electronic switches on the secondary side of the transformers can be significantly reduced.

Although the present disclosure has been disclosed in the preferred embodiments, any person skilled in the art can make various changes and modifications without departing from the spirit and scope of the present disclosure. Therefore, the protection scope of the present disclosure shall be determined by the appended claims.

What is claimed is:

1. A power converter, comprising:
two transformers, wherein primary sides of the two transformers are connected in series to form a primary series assembly;
an input switch assembly comprising a first bridge arm and a second bridge arm connected in parallel, wherein the first bridge arm comprises a first switch and a second switch connected in series to form a first node, the second bridge arm comprises a third switch and a fourth switch connected in series to form a second node, and the input switch assembly is configured to operate in a full-bridge mode or a half-bridge mode; wherein the primary series assembly and an input capacitor are connected in series between the first node and the second node; and
a control module electrically connected to the input switch assembly;
wherein the control module is configured to perform operations comprising:
controlling the third switch and the fourth switch to be turned on and off complementarily;
in response to the input switch assembly being switched from the full-bridge mode to the half-bridge mode, controlling a duty cycle of a control signal for the first switch asynchronous with a control signal for the fourth switch to be reduced to zero gradually, and controlling a duty cycle of a control signal for the second switch asynchronous with a control signal for the third switch to be raised to one gradually; and
in response to the input switch assembly being switched from the half-bridge mode to the full-bridge mode, controlling the duty cycle of the control signal for the first switch to be raised from zero gradually to make the control signal for the first switch asynchronous with the control signal for the fourth switch, and controlling the duty cycle of the control signal for the second switch to be reduced from one gradually to make the control signal for the second switch asynchronous with the control signal for the third switch, to control the first switch and the second switch to be turned on and off complementarily.

2. The power converter as claimed in claim 1, wherein in response to the input switch assembly being switched from the half-bridge mode to the full-bridge mode, there is a phase shift between the control signal for the first switch and the control signal for the fourth switch, and wherein the phase shift is set within a phase-shift range, which is greater than 0 degree and not more than 180 degree.

3. The power converter as claimed in claim 1, wherein the input capacitor is electrically connected between the first node and the primary series assembly.

4. The power converter as described in claim 1, wherein secondary sides of the two transformers are connected in series to form a secondary series assembly, the secondary series assembly is connected to an output switch assembly in parallel, and the output switch assembly is electrically connected to the control module.

5. The power converter as claimed in claim 4, wherein the secondary sides of the two transformers are connected to form a first contact, the output switch assembly comprises a fifth switch and a sixth switch connected in series to form a second contact, and an output capacitor is electrically connected between the first contact and the second contact.

6. The power converter as claimed in claim 1, wherein the control module is configured to control the input switch assembly to be switched from the full-bridge mode to the half-bridge mode in response to determining an input voltage associated with the input switch assembly being greater than a voltage threshold, and the control module is configured to control the input switch assembly to be switched from the half-bridge mode to the full-bridge mode in response to determining the input voltage being less than or equal to the voltage threshold.

7. A power converter, comprising:
two transformers, wherein primary sides of the two transformers are connected in series to form a primary series assembly;
an input switch assembly comprising a first bridge arm and a second bridge arm connected in parallel, wherein the first bridge arm comprises a first switch and a second switch connected in series to form a first node, the second bridge arm comprises a third switch and a fourth switch connected in series to form a second node, and the input switch assembly is configured to operate in a full-bridge mode or a half-bridge mode, and the primary series assembly is connected between the first node and the second node; wherein the first node is electrically connected to a third node via a back-to-back switch assembly, and the third node is formed by two input capacitors connected in series; and
a control module electrically connected to the input switch assembly and the back-to-back switch assembly;
wherein the control module is configured to perform operations comprising:
controlling the third switch and the fourth switch to be turned on and off complementarily;
in response to the input switch assembly being switched from the full-bridge mode to the half-bridge mode, controlling a duty cycle of a control signal for the first switch asynchronous with a control signal for the fourth switch to be reduced to zero gradually, controlling a duty cycle of a control signal for the second switch asynchronous with a control signal for the third switch to be reduced to zero gradually, and controlling the back-to-back switch assembly to be turned on; and
in response to the input switch assembly being switched from the half-bridge mode to the full-bridge mode, controlling the duty cycle of the control signal for the first switch to be raised from zero gradually to make the control signal for the first switch asynchronous with the control signal for the fourth switch, and controlling the duty cycle of the control signal for the second switch to be raised from zero gradually to make the control signal for the second switch asynchronous with the control signal for the third switch, to control the first switch and the second switch to be turned on and off complementarily, and controlling the back-to-back switch assembly to be turned off.

8. The power converter as claimed in claim 7, wherein in response to the input switch assembly being switched from the half-bridge mode to the full-bridge mode, there is a phase shift between the control signal for the first switch and the control signal for the fourth switch, and wherein the phase shift is set within a phase-shift range, which is greater than 0 degree and not more than 180 degree.

9. The power converter as described in claim 7, wherein secondary sides of the two transformers are connected in series to form a secondary series assembly, the secondary series assembly is connected to an output switch assembly in parallel, and the output switch assembly is electrically connected to the control module.

10. The power converter as claimed in claim 9, wherein the secondary sides of the two transformers are connected to form a first contact, the output switch assembly comprises a fifth switch and a sixth switch connected in series to form a second contact, and an output capacitor is electrically connected between the first contact and the second contact.

11. The power converter as claimed in claim 7, wherein the control module is configured to control the input switch assembly to be switched from the full-bridge mode to the half-bridge mode in response to determining an input voltage associated with the input switch assembly being greater than a voltage threshold, and the control module is configured to control the input switch assembly to be switched from the half-bridge mode to the full-bridge mode in response to determining the input voltage being less than or equal to the voltage threshold.

12. The power converter as claimed in claim 7, wherein the two input capacitors are connected in series to form an input capacitor assembly connected to the input switch assembly in parallel.

13. A power converter control method, applied to a power converter comprising two transformers, an input switch assembly, and a control module, wherein primary sides of the two transformers are connected in series to form a primary series assembly, the input switch assembly comprises a first bridge arm and a second bridge arm connected in parallel, the first bridge arm comprises a first switch and a second switch connected in series to form a first node, and the second bridge arm comprises a third switch and a fourth switch connected in series to form a second node, wherein the input switch assembly is configured to operate in a full-bridge mode or a half-bridge mode; wherein in a first configuration, the primary series assembly and an input capacitor are connected in series between the first node and the second node, and the control module is electrically connected to the input switch assembly; or, in a second configuration, the first node is electrically connected to a third node via a back-to-back switch assembly, wherein the third node is formed by two input capacitors connected in series, and the control module is electrically connected to the input switch assembly and the back-to-back switch assembly; wherein the method comprises:
configuring the control module to perform operations comprising:
controlling the third switch and the fourth switch to be turned on and off complementarily;
for the first configuration:
in response to the input switch assembly being switched from the full-bridge mode to the half-bridge mode, controlling a duty cycle of a control signal for the first switch asynchronous with a control signal for the fourth switch to be reduced to zero gradually, and controlling a duty cycle of a control signal for the second switch asynchronous with a control signal for the third switch to be raised to one gradually; and
in response to the input switch assembly being switched from the half-bridge mode to the full-bridge mode, controlling the duty cycle of the control signal for the first switch to be raised from zero gradually to make the control signal for the first switch asynchronous with the control signal for the fourth switch, and controlling the duty cycle of the control signal for the second switch to be reduced from one gradually to make the control signal for the second switch asynchronous with the control signal for the third switch, to control the first switch and the second switch to be turned on and off complementarily;
for the second configuration:
in response to the input switch assembly being switched from the full-bridge mode to the half-bridge mode, controlling a duty cycle of a control signal for the first switch asynchronous with a control signal for the fourth switch to be reduced to zero gradually, controlling a duty cycle of a control signal for the second switch asynchronous with a control signal for the third switch to be reduced to zero gradually, and controlling the back-to-back switch assembly to be turned on; and
in response to the input switch assembly being switched from the half-bridge mode to the full-bridge mode, controlling the duty cycle of the control signal for the first switch to be raised from zero gradually to make the control signal for the first switch asynchronous with the control signal for the fourth switch, and controlling the duty cycle of the control signal for the second switch to be raised from zero gradually to make the control signal for the second switch asynchronous with the control signal for the third switch, to control the first switch and the second switch to be turned on and off complementarily, and controlling the back-to-back switch assembly to be turned off.

14. The method as claimed in claim 13, wherein in response to the input switch assembly being switched from the half-bridge mode to the full-bridge mode, there is a phase shift between the control signal for the first switch and the control signal for the fourth switch, and wherein the phase shift is set within a phase-shift range, which is greater than 0 degree and not more than 180 degree.

15. The method as claimed in claim 13, wherein the control module is configured to control the input switch assembly to be switched from the full-bridge mode to the half-bridge mode in response to determining an input voltage associated with the input switch assembly being greater than a voltage threshold, and the control module is configured to control the input switch assembly to be switched from the half-bridge mode to the full-bridge mode in response to determining the input voltage being less than or equal to the voltage threshold.

16. The method as claimed in claim 13, wherein in the first configuration, the input capacitor is electrically connected between the first node and the primary series assembly.

17. The method as claimed in claim 13, wherein in the first configuration or the second configuration, secondary sides of the two transformers are connected in series to form a secondary series assembly, the secondary series assembly is connected to an output switch assembly in parallel, and the output switch assembly is electrically connected to the control module.

18. The method as claimed in claim 17, wherein the secondary sides of the two transformers are connected to form a first contact, the output switch assembly comprises a fifth switch and a sixth switch connected in series to form a second contact, and an output capacitor is electrically connected between the first contact and the second contact.

19. The method as claimed in claim 13, wherein in the second configuration, the two input capacitors are connected in series to form an input capacitor assembly connected to the input switch assembly in parallel.

20. The method as claimed in claim 13, wherein the control module is configured to receive at least one command instructing the power converter to be configured for the first configuration or the second configuration.
